(19) United States
(12) Patent Application Publication
(10) Pub. No.: US 2010/0084993 A1
(43) Pub. Date: Apr. 8, 2010

(54) Type of LED light

(76) Inventor: Xiao'an Sun, Beijing (CN)

Correspondence Address: Xiao'an Sun, 1301 Oak Springs Place, Lake Mary, FL, 32746, US

(21) Appl. No.: 11/988,854

(22) PCT Filed: Feb. 11, 2007
(86) PCT No.: PCT/CN2007/003118

§ 371 Date: Jan. 15, 2008

(30) Foreign Application Priority Data
Nov. 21, 2006 (CN) 200610145518.X

(51) Int. Cl. H05B 37/02

(52) U.S. Cl. 315/294

(57) ABSTRACT

An LED bulb includes at least one group of LED string (6) which is composed of a plurality of LEDs connected in series. It is supplied by a DC power source. The working current of the LEDs is adjusted by changing the number of the LEDs in the LED string (6) so as to ensure that the LEDs can operate normally.

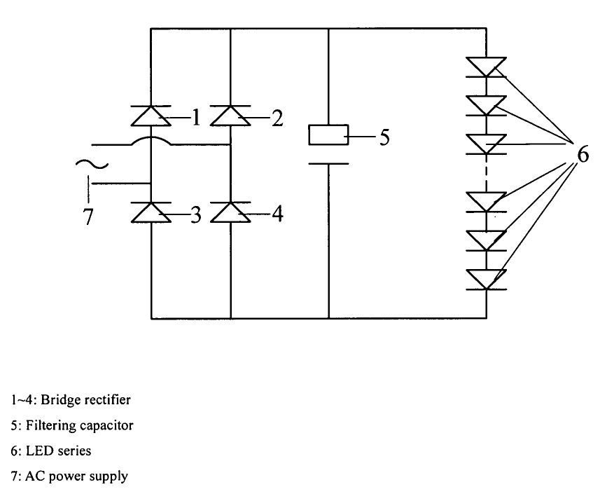

### TECHNICAL FIELD

This invention is for a type of LED light, which is suitable for many different lighting applications.

### TECHNOLOGY BACKGROUND

Because LED (Light Emitting Diode) lighting has many advantages such as high efficiency, low power consumption, and long life, it has become the focused development direction for future lighting solutions.

Currently, LED lighting is mostly used in automotive lighting, traffic signal, background lighting, and neon signs. It is not commonly used in household and general lighting applications. This is because of the characteristics of the LED itself. The high brightness LED on the market today has a working current (IF) about 20 mA and working voltage (VF) about 3.2V, thus working power consumption about 64 mW. For general lighting application, a minimum of about 3 W power consumption is needed. So many LEDs need to be connected together to meet the power requirement. LED needs a working current about 20 mA to emit light efficiently, but because LED is non-linear device and different LEDs may require slightly different working voltage, if many LEDs are connected in parallel to the same voltage, some may not have enough working current to emit light while others may have current exceeding working condition. Thus, in order to use LEDs in parallel, each LED needs to have its own current regulator, which is not practical. Another challenge to household LED lighting is to use the household power supply which is 110V AC to power the LED device, which requires a DC voltage of about 3V. Some solutions involve transformer, current regulator, or other control circuits. But they add to power consumption and product cost.

This invention delivers a solution that can use normal household power supply to power stable, long life, high efficiency LED light that can meet any power requirement.

### THE INVENTION

This invention solves the problem of using low voltage, low power LED device in high voltage, high power environment.

Instead of using additional circuitry to control current or voltage of the LED device, this invention uses appropriate number of LED devices in series to guarantee the working current of the LEDs. The novelty of this invention is not changing the power supply to meet LED requirements, but adjusting the number of LEDs in series to adapt to the power supply.

The normal household outlet provides 110V AC power, which will deliver about 150V DC after bridge rectifier and filter. When each LED device requires about 3.2V working voltage under 20 mA working current, and provide about 64 mW lighting power, we can put 47 LEDs together in series and connect them directly to the 150V DC power mentioned above. Since the working voltage requirement on each LED differs only slightly, overall total working voltage on the LED series will be close to 150V DC, thus the working current will be about 20 mA. That will give us about 3 W of lighting power. This way, we can use LED device directly in this high voltage environment (110V AC) to deliver high lighting power (3 W) without using transformer, current regulator, or other control circuitry. The complete lighting solution consists of only bridge rectifier, filtering capacitors, and LED series.

When we need lighting power greater than 3 W, we can use multiple LED series described above and connect them in parallel. The household power supply is more than capable of handling almost any practical numbers of such LED series connected in parallel, thus any practical wattage of lighting power. Because the normal household circuit breaker can handle at least 10 A of current, which can supply 500 of above mentioned LED series connected in parallel and providing 1500 W of lighting power.

The benefit of this invention is to enable a lighting solution that is completely compatible with the traditional light bulb, with higher efficiency, lower power consumption, longer life, and can meet any practical lighting power requirement.

1. A LED light with the following characteristics: At least one set of LEDs connected in series, powered by DC power supply. Guarantee LED normal working condition by adjusting the number of LEDs in series to control the working current.

2. A LED light as in claim 1, with the following characteristics: When using household AC power supply, going through bridge rectifier, isolating, and filtering to obtain higher DC voltage to power the LED series.

3. A LED light as in claim 1 and 2, with the following characteristics, connecting multiple LED series in parallel to achieve higher power light.
